(19) United States
(12) Patent Application Publication
(10) Pub. No.: US 2012/0278183 A1
(43) Pub. Date: Nov. 1, 2012

(54) SCRIPTING LANGUAGE, METHOD AND SYSTEM FOR DELIVERING PLATFORM-INDEPENDENT DYNAMICALLY INTERPRETED AND RENDERED INTERACTIVE CONTENT, AND FOR MEASURING THE DEGREE AND NATURE OF USER INTERACTION THEREWITH

(76) Inventors: Joseph A. Fortuna, Brooklyn, NY (US); Ezra Suveyke, New York, NY (US); Justin Jay Byrne, Brooklyn, NY (US)

(21) Appl. No.: 13/437,283

(22) Filed: Apr. 2, 2012

Related U.S. Application Data
(60) Provisional application No. 61/470,285, filed on Mar. 31, 2011.

(51) Int. Cl. G06Q 30/02

(52) U.S. Cl. 705/14.72

(57) ABSTRACT

Exemplary embodiments provide a scripting language, method and system for delivering platform-independent dynamically interpreted and rendered interactive content, and for measuring the degree and nature of user interaction therewith.

### CROSS REFERENCE TO RELATED APPLICATIONS

The present application claims priority to U.S. Provisional Patent Application Ser. No. 61/470,285 filed Mar. 31, 2011, the entire contents of which are specifically incorporated by reference herein.

### BACKGROUND

### Platform Independence

At the time of this writing, the principle delivery mechanism for interactive advertising content is a byte-code compiled framework known as Flash. Flash is a proprietary platform originally created by MACROMEDIA and subsequently purchased by ADOBE.

Flash is a vector-based animating system that includes support for display of other video and graphical assets in a timeline context, producing “Rich Media” animated content as well as portable video presentations.

Because of its flexibility and the widespread adoption of its client software, Flash remains the “go to” software of choice for both “Rich Media” and video advertising in the digital context.

However, recent years have brought with them the introduction to market of a vast array of increasingly mobile devices, many of which do not offer any native support for flash presentations. In addition, Internet standards such as HTML5 are pushing the boundaries of what can be done using un-enhanced browser technology. And all of this is to say nothing of alternative client-side rendering environments (Java, Python, desktop compiled code, etc.).

There is clearly a need for a method of delivering and rendering interactive advertising content that is independent of any specific vendor or vendor's technology.

There are currently a number of different candidates for a standard method of data exchange between rendering components and enclosing containers (players) among them, the VPAID (Video Player-Ad Interface Definition) is emerging as a leader, but a balkanized state still exists among the various player platforms. Many of them implement their own custom mechanism for data exchange. If these methods can be abstracted and pushed into scripted directives, then the renderer would be infinitely adaptable.

What is needed in the art are improved mechanisms for platform independent rendering of interactive advertising content.

### Dynamic Interpretation

Further, as mentioned above, the bulk of what is currently available in the way of interactive advertising presentations is delivered as pre-compiled programming. Typically (as in the case of Flash ads) this is a timeline-synched combination of video, advertising and interactive componentry that is then “mixed-down” into a packaged format. Any alteration of that format after the point of compilation (e.g. in run-time) is impossible.

Within the domain of Internet media, there is a multiplicity of agenda, legal overhead, messaging initiatives and revenue considerations. Given the rate of change of public sentiment, the changing nature of brand imagery and the unpredictable tide of consumer spending, it is clear that a pre-compiled, unalterable format presents a significant barrier to the advertiser seeking to respond quickly and effectively to the demands of the market for her product.

Similarly, the eventual appearance of a given interactive advertising presentation takes as many forms as there are players, browsers, operating systems, and specification for computer hardware connected to the Internet. A “static”, compiled ad presentation essentially robs the Media Composer of the ability to adjust the presentation or offer alternate layouts more “tuned” to unexpected client configurations.

Accordingly, what is also needed in the art are improved mechanisms for rendering of interactive advertising content that avoids the problems with traditional static, compiled ad presentations.

### Measuring User Interaction

The market advantage of the Internet over more traditional, passive channels for content delivery (print, radio, television) is the level of interactivity offered to the end user. Current models for delivery of Internet content use a collection of available technology to retro-fit tracking and monitoring to interactive presentations. Such presentations are typically built with a primary focus on the degree to which a user can interact with the content. Measuring the nature and extent of that interaction is generally an afterthought.

Clearly, a mechanism for delivering content which is built with metrics and monitoring as a critical underlying component of its essential design would have an advantage over the current, somewhat cobbled-together solutions.

### SUMMARY OF THE INVENTION

The above described and other problems and disadvantages of the prior art are overcome and alleviated by the present scripting language, method and system for delivering platform-independent dynamically interpreted and rendered interactive content, and for measuring the degree and nature of user interaction therewith.

Exemplary embodimetns provide a structured language and specification that can be dynamically interpreted by properly-constructed software. The language and specification allow for the creation of a limitless range of interactive media formats.

Further exemplary embodiments provide a scripted directive interface to the mechanism for data exchange between the renderer and any enclosing container.

Other exemplary embodiments provide a mechanism that ensures that the interpretation of this language isn't tied to any specific hardware or software framework.

Other exemplary embodiments provide a mechanism that facilitates the run-time alteration of atoms of content created using the structured language.

Other exemplary embodiments provide a mechanism that provides sufficient intrinsic structure within the language, specification and associated systems and methods to enable unqualified support for the capture and indexing of data reflecting the scope and nature of user interaction with the media formats being presented.

The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the FIGURES:

FIG. 1 illustrates an exemplary workflow for the creation and distribution of interactive presentations; and

FIG. 2 illustrates a layout of a given ADML presentation as defined in terms of asset positioning within an M×N grid.

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will also be understood that the terms “media,” “multi-media,” “video,” or any variation thereof may be interchangeable. Thus any form of media may be applicable to example embodiments.

It should also be understood that other terms used herein may be applicable based upon any associated definition as understood by one of ordinary skill in the art, although other meanings may be applicable depending upon the particular context in which terms are used.

Further to the brief description provided above and associated textual detail of each of the FIGURES, the following description provides additional details of example embodiments of the present invention.

There are three possible parties involved in the creation, and distribution of these interactive presentations: the Composer, the Agency, or the Publisher. Note that an exemplary aspect of this invention is that the Composer could share roles with either the Agency or the Publisher. In any event, the Composer and end user will be referred to in the alternative below for the sake of describing an exemplary work flow process.

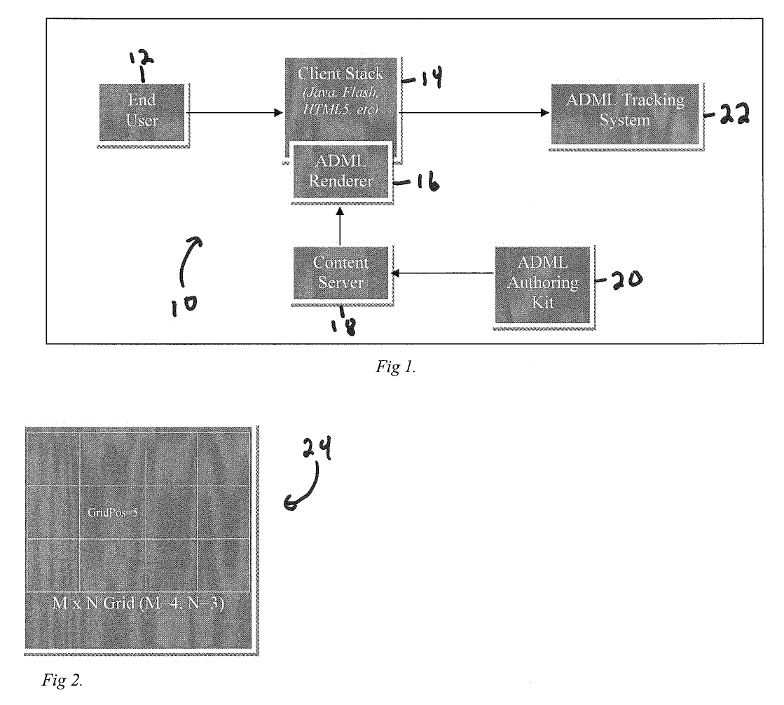

Referring now to FIG. 1, an exemplary workflow proceeds as follows and is illustrated generally at 10: the end user uses a combination of the Interactive Authoring Utility and hand-typed blocks of the Structured Language (ADML) to generate an Interactive Presentation.

In the course of delivery of an ADML presentation, the end user would complete her creation of the unit, save it to the content repository (along with any associated assets), and schedule delivery of the asset. Referring still to FIG. 1, the end user 12 interacts with a client stack 14 (such as Java, Flash, HTML5, etc.) and an ADML renderer 16 to complete the creation of the unit. Such renderer 16 may also draw from a content server 18 and associated ADML authoring kit 20 in such creation.

Subsequent distribution of the requisite information within a given network of content distributors would result in that presentation being delivered throughout the network. User interaction with the presentation (identified through the intrinsic mechanism of EventTags—see below) is then tracked and recorded by the ADML Tracking system 22.

### ADML

### Data Exchange

The present exemplary ADML scripting language takes advantage of the increasing prevalence of reflexivity within the sphere of interpreted and compiled languages. Using this feature, ADML exposes a structured mechanism for defining the properties, methods and events associated with data exchange between an ADML renderer and a containing entity.

### Data Exchange Example

<ADML>

<DataExchange name=”VPAID” version=”1.1”>

<Methods>

<Method name=”initAd”>

<Parameters>

<Param><Name>width</Name><Type>Number</Type></P
aram>
<Param><Name>height</Name><Type>Number</Type></
Param>
<Param><Name>viewMode</Name><Type>String</Type>
</Param>
<Param><Name>desiredBitrate</Name><Type>Number<
/Type></Param>
<Param><Name>creativeData</Name><Type>String</T
ype></Param>
<Param><Name>environmentVars</Name><Type>String
</Type></Param>

</Parameters>

</Method>
...

</Methods>

</DataExchange>

</ADML>

### Layout

To incorporate the idea that it's possible and indeed likely that a Composer would not know a priori which of the multiplicity of client configurations will be the ultimate destination for the Composer's presentation, the layout of a given ADML presentation may be defined in terms of asset positioning within an M×N grid. ADML nodes: GridRow, GridCol and GridPos are used to place a given “Tile” (see below) on a predefined square on that grid (see FIG. 2, generally at 24).

### Slate

The root-level container entity for an ADML Presentation may be termed the Slate. The Slate carries with it certain global identifying and configuration information that instruct the renderer how to proceed laying out the presentation.

### SlateExample:

<Slate width=“768” height=“432” id=“12345”>
<Primary id=“12345” rootLayoutId=“12345”/>
<TriggerPoint>TIGGER_25</TriggerStart>
...
</Slate>

### Tiles

The central organization unit within ADML is the “Tile”. In addition to stylistic and layout parameters, Tiles contain collections of Events, TextFields, Graphics, and Widgets.

### Events

An Event is the principle atomic unit of interactivity withing an ADML presentation. Actions exists in collections at the Slate, Tile, and Graphic and Widget level (Widget actions can be specified within the logic of the widget itself, or as part of the ADML specifying the node).

The EventTag contains a unique character string that is used by the ADML Tracking system to index, calculate and report on the number of users that have performed a given action.

### Event Example:

<Events>

<Event id=“myEvent” type=“click” action=“play”>

<EventTag>click_myEvent</EventTag>

</Event>

</Events>

### Graphics, Text, Fonts

Native support in ADML may be provided for the inclusion of static graphics (.jpg, .gif, .png files) as well as styled text. The style directives for the text elements is mapped directly to established conventions such as those found in the Cascading Style Sheet specification for HTML.

### Graphic Example:

<Tile id=“myGraphic”>

<GridRow>1</GridRow>
<Graphic>

<URL><![CDATA[http://myserver.com/myImg.jpg</URL>

</Graphic>

</Tile>

### Text Example:

<Tile id=“myGraphic”>

<GridRow>1</GridRow>
<Graphic>

<URL><![CDATA[http://myserver.com/myImg.jpg</URL>

</Graphic>
<TextFields>

<TextField align=“top”>

<TextStyle><![CDATA[{text-
align:center;width:400px;color:#111111;font-
family:arial;font-size:16px;font-
weight:bold;}]]></TextStyle>
<Caption><![CDATA[Example of a textfield designed to
appear above graphic]]></Caption>

</TextField>

</TextFields>

</Tile>

As evidenced in the syntax, support exists for multiple text blocks within a single Tile.

### Widgets

In exemplary embodiments, certain logical assets or “Widgets” within the presentation (such as precompiled flash files, or external Java classes, or external javascript libraries—depending on the rendering platform) can be created for inclusion in the Interactive Presentation, and can (as implied) be constructed to suit any rendering platform, so long as they are built according to the invention's specifications.

Specifically, each such asset may expose a single “init” function which accepts an ordinary string variable as a parameter. Additionally, if it is the intention of the Composer that a given logical asset communicate with the Interactive Presentation as a collection (or its container), then the logical asset may be written so as to “fire” (e.g. generate) a “customAction” event at the moment such communication is desired.

To further refine the communication, the logical asset may expose a “getAction” function which returns with a generic “Action” object, the properties and methods of which contain directives to the Interactive Presentation and its renderer.

### Widget Example:

<Tile id=“myWidget”>

<GridRow>1</GridRow>
<Widget customAction=“true”>

<URL><![CDATA[http://myserver.com/myImg.jpg</URL>

</Widget>

</Tile>

### Logic

ADML, additionally, offers a layer of abstraction that, in exemplary embodiments, allows the operator access to logical operations not typically found in markup languages, that allow for rapid creation of serialized content, or content with a more customized level of user interaction. Objects and variables can also be defined, as targets for events, or Boolean value checks, to store values, etc.

### Variables

Variables in ADML allow the operator to extend her creations and create more dynamic content. Variable scope is determined by where the variable is defined (as with most compiled languages).

### “Global” Variable:

<Slate>

<Variable
name=”video35percent”><Value>false</Value></Variable>

</Slate>

### “Global” Variable (Initialized Null):

<Slate>

<Variable name=”video35percent”></Variable>

</Slate>

Set Variable from Other Block:

<Event id=”my35PercentEvent” type=”custom” action=”custom”>

<EventImplement>

<![CDATA[{video.progress:35,value:”>=”}]]>

</EventImplement>
<EventAction>

<Variable>

<Name>video35percent</Name>
<SetValue>true</SetValue>

</Variable>

</EventAction>

</Event>

Variables can also be defined in a <Variables> block

### Objects

Objects in ADML further allow the operator to extend her creations and create more dynamic content. Objects can also be used to implement extensions to the renderer. Object scope is determined by where the object is defined (as with most compiled languages). Within a <DataObject> node, all child nodes will be objectified (names are extensible outside the ADML Spec).

### “Global” Object:

<Slate>

<DataObjects>

<DataObject name=”gameObject”>

<KickedBall type=”counter”>0</KickedBall>
<Jumped type=”counter”>0</Jumped>
<GameFinished type=”Boolean”>false</GameFinished>
<Events>

<Event></Event>

</Events>
<Methods>

<Method></Method>

</Methods>

</DataObject>

</DataObjects>

</Slate>

### For Loop/If Else

A For Loop for Tile creation (this would exist within a Slate block). Terms within the loop bracketed with %% are replaced by the renderer, some replacement terms are built in (COUNT (loop value), DATETIME (client datetime), etc.).

### For Loop Example:

<For length=”3”>

<Operations>

<Operation>

<Assets replaceStr=”ASSET_VALUE_IMAGE”>

<Array>

<![CDATA[assets/url1.jpg,assets/url2.jpg,assets

/url3.jpg]]>
</Array>

</Assets>
<Execute>

<Tile id=”tile%COUNT%”>

<GridRow>2</GridRow>
<Graphic>

<URL>

<![CDATA[%ASSET_VALUE_IMAGE%]]>

</URL>

</Graphic>

</Tile>

</Execute>

</Operation>

</Operations>

</For>

As evidenced by the syntax, multiple operations can be performed in each loop. Assets can be text, xml, or binary files (and can additionally be defined by an <Asset></Asset> list of blocks, rather than a comma delineated array)

Boolean operations can also be assigned to a given object to modify their behavior.

<Tile id=”closeBtn”>

<Events>

<Event id=”clicked_close” type=”click” action=”custom”>

<EventImplement>

<Operations>

<Operation>

<If check=”video35percent”>

<![CDATA[{closeContent;}]]>

</If>
<Else>

<![CDATA[{showTile:funWarn;}]]>

</Else>

</Operation>

</Operations>

</EventImplement>

</Event>

</Events>

</Tile>

Note that check can also be implemented as a node (<Check></Check>) for complex expressions in which case the value of the if node changes to an Operations block

### AdScript

Much of the logical underpinnings of ADML may be enacted through the use of AdScript. AdScript is a separate evolving spec which currently consists of JSON-like name-value pairing, the name of which is typically a verb and the value of which is typically a noun (think predicate-subject pairings).

### Example of AdScript:

deactivate:thumbnailTile;video:pause;

### ADML Authoring Toolkit

### Summary

An exemplary ADML Authoring Toolkit (Authkit) is designed to streamline the process of creating, maintaining, and testing ADML based content and presentations, as well as removing operator error from the process of creating ADML. The Authkit may make decisions to streamline and reduce the amount of ADML that needs to be created to render a given presentation, such as replacing a set of tiles with a For-loop notation to serially generate them (in the case the multiple tiles are assigned to a single row or column, their properties will be abstracted to arrays, and the individual tile declarations will fall away).

The Authkit can also be used to load existing ad templates to give the operator a substrate from which to work.

The Authkit can additionally leverage the ADML Renderer (which exposes API hooks in order to facilitate communication with the Authkit, and drag and drop positioning, and input field property adjustment).

In exemplary embodiments, the ADML renderer also manages a set of objects that represent all DOM objects added in service of rendering the ADML (Tiles, background, etc.). These objects are updated whenever an object on the stage is modified.

### Templates

Templates may take the form of standard ADML used in the creation of previous presentations or projects. A menu in the Authkit allows access to, and JPEG and descriptive samples of previous or commonly used projects. These previews allow the user to load in a previous project's ADML as a starting point for their own project.

### Panels

The GUI of the Authkit may be broken into three primary panels: the rendering and layout panel, the item level controls panel, and the document level controls panel.

### Rendering and Layout

In exemplary embodiments, the rendering and layout panel leverages the ADML Renderer to display presentations in full detail. Tiles rendered in the space may be draggable, resizable, and their properties are exposed through the internal ADML renderer's API. A tile can be locked into a row, column, or any position within the layout grid.

In exemplary embodiments, moving Tiles on the stage alters the API.

### Output

The Authkit can be tied directly into a data service to export data directly, or can export ADML to a panel in the GUI for the user to paste into their publisher environment.

### Extensibility

The Authkit can be extended by accessing its API, potentially allowing for a variety of functions such as productivity tracking, source control, and so on.

### ADML Parsing and Rendering

### Objectification of Markup

In exemplary embodiments, the ADML scripting language can be delivered to the ADML Parser in a variety of methods, either as a standalone code payload, or as part of a larger XML feed. The ADML Parser then can transform whatever feed, and the ADML itself into generic objects, based on a JSON formatted specification validation. As the parser iterates over the given specification, it checks whether to expect each node to have children, attributes, or whether there are special processing directives for that particular child.

The objectified feed and ADML may then be available for use from the ADML manager class.

### Rendering Generic ADML Object

In exemplary embodiments, the ADML Renderer is an extensible system that accepts a generic object from the ADML Parser and uses a particular set of instructions to transform that object into a graphic (and objective) representation of a specific interactive presentation.

### Data Exchange

Data exchange nodes and their children may be transformed into functional objects and exposed to whatever client is attempting to interact with the rendered ADML presentation at the top level.

### Layout

Layout instructions may be objectified and translated into generic terms in order to work with multiple versions of the ADML specification. This helps ensure that legacy ADML will be loaded in and laid out with the same instruction set that lays out any future version of ADML.

### Slate

In generic—“container”—is the top level functional node within the ADML structure. Container's children include primary display children (tiles) and a variety of document level settings, including background, video properties, overall height and width, and tracking data.

### Tiles

Each tile represents a discrete atomic element of content, whether logical, graphical or interactive (or some permutation of the three). Tiles are nestable and can interact and interoperate via the “A++” scripting language.

### Events

Events are the cornerstone of interoperability within the slate environment

### ADML Specification

The following provides an exemplary specification for use with a structured language that may be used to generate an interactive presentation in accordance with certain aspects of an exemplary embodiment of the invention.

### Extensions

The extensions node is part of the VAST spec that typically houses the ADML package.

Children:
SuperSlate

Node Implementation:
<Extensions></Extensions>

### SuperSlate

This is the top level container for ADML

Attributes:
width
height
display

Children:
GridSize
Primary
AutoPlay
BackgroundColor
InAdLinear
BackgroundURL
TriggerPoint
SmartTiles
ExtensionSettingsId
TrackingBase

Node Implementation:
<SuperSlate width=“ ” height=“ ” display=“ ”></SuperSlate>

GridSize

The GridSize node describes the side of the grid used to position tile elements.

Node Implementation: <GridSize></GridSize>

Primary

The Primary node signifies whether an ad is a master layout ad, or a subservient ad.

Attributes:

id value linkedld

Node Implementation: <Primary id=“ ” value=“ ” linkedId=“ ”></Primary>

AutoPlay

The AutoPlay node allows the renderer to play an ad immediately, or delay.

Node Implementation: <AutoP lay></AutoP lay>

SFM-0019US2 16

### BackgroundColor

The BackgroundColor node tells the renderer to alter the background color.

Node Implementation:
<BackgroundColor></BackgroundColor>

### InAdLinear

InAdLinear specifies that an ad's content . . .

Node Implementation:
<InAdLinear></InAdLinear>

### BackgroundURL

The BackgroundURL node tells allows the user to specify a background image.

Attributes:
height
width
display

Node Implementation:
<BackgroundURL height=“ ” width=“ ” display=“ ”></BackgroundURL>

### TriggerPoint

TriggerPoint allow the user to specify when the ads impressions will begin dispatch

Node Implementation:
<TriggerPoint></TriggerPoint>

### SmartTiles

SmartTiles is a wrapper node for individual SmartTile nodes

Children:
SmartTile

Node Implementation:
<SmartTiles></SmartTiles>

### SmartTile

SmartTile is the primary layout element within the ADML specification

Attributes:
width
height
id
order
opacity

Children:
GridRow
GridCol
GridPos
TileStyle
TextFields
Transitions
Tile
Actions
Video
TimeoutSeconds
TimeoutCaption
TimeoutStyle

Node Implementation:
<SmartTile width=“ ” height=” id=“ ” order=“ ” opacity=“ ”></SmartTile>

### GridRow

GridRow locks a tile into a specific row within the layout, row locked tiles will be centered based on the number of tiles in the row

Node Implementation:
<GridRow></GridRow>

GridCol

GridCol locks a tile into a specific column within the layout, column locked tiles will be centered based on the number of tiles in the column

Node Implementation:
<GridCol></GridCol>

### GridPos

GridPos locks a tile into a specific position within the layout.

Node Implementation:
<GridPos></GridPos>

### TileStyle

TileStyle allows the user to describe alterations to the SmartTile's layout and display style using CSS and CSS like properties.

Node Implementation:
<TileStyle></TileStyle>

### TextFields

TextFields node is a wrapper for individual TextField nodes.

Children:
TextField

Node Implementation:
<TextFields></TextFields>

### TextField

The TextField node allows the user to define a text field or a caption within a tile.

Children:
Caption
TextStyle

Node Implementation:
<TextField></TextField>

### Caption

The Caption Node allows the user to define text for the TextField node.

Node Implementation:
<Caption></Caption>

### TextStyle

TextStyle describes the style of the text contained within the Caption node.

Node Implementation:
<TextStyle></TextStyle>

### Transitions

The Transitions node allows the use to define transitions in a plain english style.

Node Implementation:
<Transitions></Transitions>

### Tile

Tile nodes allow the user to embed graphics and widgets within the SmartTile.

Attributes:
customAction

Children:
Value

Node Implementation:
<Tile customAction=“ ”></Tile>

### Value

Value is a catchall node that can nest within most other objectified supernodes.

Node Implementation:
<Value></Value>

### Actions

The Actions node serves as a wrapper for individual action nodes.

Children:
Action

Node Implementation:
<Actions></Actions>

### Action

The Action node allows the user to define behavior for each SmartTile.

Attributes:
id

Children:
ActionType
ActionTag
ActionNext
ActionURL
ActionCode

Node Implementation:
<Action id=“ ”></Action>

### ActionType

The actionType node allows the user to communicate whether an action is predefined within the ADML renderer or whether the action is going to be defined within the ADML block.

Node Implementation:
<ActionType></ActionType>

### ActionTag

The ActionTag node allows the user to name the action block for reference by other action nodes and other tiles.

Node Implementation:
<ActionTag></ActionTag>

### ActionNext

Presence of the ActionNext node allows the user to signify the next executed action in the stack.

Node Implementation:
<ActionNext></ActionNext>

### ActionURL

If the action is a generic referral, ActionURL allows the user to specify the destination of the referral.

Node Implementation:
<ActionURL></ActionURL>

### ActionCode

The ActionCode node allows the user to define the code executed within the action block

Node Implementation:
<ActionCode></ActionCode>

### Video

The Video node allows a positioned SmartTile to house the ad video for.

Attributes:
width
height
stretch

Children:
URL
SourceFLV
SourceOGG
SourceWEBM
SourceMP4

Node Implementation:
<Video width=“ ” height=“ ” stretch=“ ”></Video>

### URL

URL is a catchall child designed to wrap URLs for assets (images, widgets, videos, or other payloads).

Node Implementation:
<URL></URL>

### SourceFLV

SourceFLV defines an FLV url for an HTML5 video node.

Node Implementation:
<SourceFLV></SourceFLV>

### SourceOGG

SourceOGG defines an Ogg url for an HTML5 video node.

Node Implementation:
<SourceOGG></SourceOGG>

### SourceWEBM

SourceWEBM defines a WedMedia url for an HTML5 video node.

Node Implementation:
<SourceWEBM></SourceWEBM>

### SourceMP4

SourceMP4 defines an MP4 url for an HTML5 video node.

Node Implementation:
<SourceMP4></SourceMP4>

### TimeoutSeconds

TimeoutSeconds allows the user to define the length of the timeout.

Node Implementation:
<TimeoutSeconds></TimeoutSeconds>

### TimeoutCaption

TimeoutCaption defines the verbiage of the timeout text.

Node Implementation:
<TimeoutCaption></TimeoutCaption>

### TimeoutStyle

The TimeoutStyle node allows the user to style the timeout text readout.

Node Implementation:
<TimeoutStyle></TimeoutStyle>

### ExtensionSettingsId

ExtensionSettingsId allows for the passing of directives to the tracking server.

Node Implementation:
<ExtensionSettingsId></ExtensionSettingsId>

### TrackingBase

TrackingBase allows for the passing of directives to the tracking server.

Node Implementation:
<TrackingBase></TrackingBase>

### CONCLUSION

In summary, various exemplary embodiments of the above-described interactive digital video markup language (ADML) make it possible to offer interactive digital video in improved ways over those previously available. Run-time control may be provided over the actual format of interactive advertisements, placing such control in the hands of every advertising stakeholder. In such a way, formats are no longer the exclusive domain of custom creative organizations.

Exemplary embodiments of ADML give control over the layout of ad formats, whether the ad is to run as a linear or non-linear ad, what the makeup of the tracking pixels should be in response to user interaction, how the renderer should respond to publisher-submitted data, etc. Animation, transitions, alpha effects and shadowing may all be supported natively in ADML. User-defined ADML widgets can provide a wide variety of interactivity, all ADML compliant. Widgets respond to ADML directives the same way native ADML elements do, giving designers, publishers, and campaign managers control over the experience.

ADML can also be updated and configured on the fly. That means layout and graphic changes can be done from the trafficker's (or publisher's, or campaign manager's) workstation and the changes immediately take effect everywhere the format is deployed.

Similar to the way in which HTML allows for the dynamic update of a web page, and that JavaScript powers rich interfaces to provide responsive and intuitive user experiences, present exemplary embodiments of ADML allows designed and non-technical personnel to make immediate changes to ad formats (including ASq) whenever necessary.

ADML also can provide a richly-designed authoring tool kit. Users of the ADML authoring tool kit may design their own ADML powered ads using an intuitive drag-and-drop interface.

Further, presently described embodiments of ADML are platform independent, as multiple ADML renderers may be provided and constructed in any language or environment that supports a graphical interface, using the ADML specification.

It is further noted that embodiments of the invention may be embodied in the form of computer-implemented processes and apparatuses for practicing those processes. Therefore, according to an exemplary embodiment, the methodologies described hereinbefore may be implemented by a computer system or apparatus. Portions or the entirety of the methodologies described herein may be executed as instructions in a processor of a computer system, which may include memory for storage of instructions and information, input device(s) for computer communication, and display devices. Thus, the present invention may be implemented, in software, for example, as any suitable computer program on a computer system. For example, a program in accordance with the present invention may be a computer program product causing a computer to execute the example methods described herein.

Therefore, embodiments can be embodied in the form of computer-implemented processes and apparatuses for practicing those processes on a computer program product. Embodiments include a computer program product on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be emphasized that the above-described example embodiments of the present invention, including the best mode, and any detailed discussion of particular examples, are merely possible examples of implementations of example embodiments, and are set forth for a clear understanding of the principles of the invention. Many variations and modifications may be made to the above-described embodiment(s) of the invention without departing from the spirit and scope of the invention. All such modifications and variations are intended to be included herein within the scope of this disclosure and the present invention and protected by the following claims.

What is claimed is:

1. A method for delivering interactive content, comprising:
providing interactive content via a structured language and specification that is configured to be dynamically interpreted by software, wherein the structured language and specification is configured as an interactive digital video markup language that is platform independent and is configured to allow run-time control over the format of interactive advertisements.

2. A method for delivering interactive content in accordance with claim 1, wherein the interactive digital video markup language is configured to give control over the layout of advertisement formats whether the ad is to run as a linear or non-linear ad, what the makeup of the tracking pixels should be in response to user interaction, and how the renderer should respond to publisher-submitted data.

3. A method for delivering interactive content in accordance with claim 1, wherein said platform independence is provided via a scripted directive interface for data exchange between the renderer and any enclosing container that ensures that interpretation of the language isn't tied to any specific hardware or software framework.

4. A method for delivering interactive content in accordance with claim 1, wherein said run time control is provided via run-time alteration of atoms of content created using the structured language.

5. A method for delivering interactive content in accordance with claim 1, further comprising providing a mechanism that provides sufficient intrinsic structure within the language, specification and associated systems and methods to enable unqualified support for the capture and indexing of data reflecting the scope and nature of user interaction with the media formats being presented.

6. A system for delivering interactive content, comprising:
providing an interactive content renderer and a client stack configured with a structured language and specification that is configured to be dynamically interpreted by software, wherein the structured language and specification is configured as an interactive digital video markup language that is platform independent and is configured to allow run-time control over the format of interactive advertisements.

7. A system for delivering interactive content in accordance with claim 6, wherein the interactive digital video markup language is configured to give control over the layout of advertisement formats whether the ad is to run as a linear or non-linear ad, what the makeup of the tracking pixels should be in response to user interaction, and how the renderer should respond to publisher-submitted data.

8. A system for delivering interactive content in accordance with claim 6, wherein said platform independence is provided via a scripted directive interface for data exchange between the renderer and any enclosing container that ensures that interpretation of the language isn't tied to any specific hardware or software framework.

9. A system for delivering interactive content in accordance with claim 6, wherein said run time control is provided via run-time alteration of atoms of content created using the structured language.

10. A system for delivering interactive content in accordance with claim 6, further comprising providing a mechanism that provides sufficient intrinsic structure within the language, specification and associated systems and methods to enable unqualified support for the capture and indexing of data reflecting the scope and nature of user interaction with the media formats being presented.
